(19) United States
(12) Patent Application Publication
(10) Pub. No.: US 2010/0054542 A1
(43) Pub. Date: Mar. 4, 2010

(54) PROCESSING VIDEO FRAMES WITH THE SAME CONTENT BUT WITH LUMINANCE VARIATIONS ACROSS FRAMES

(75) Inventors: Fitzgerald John Archibald, Thuckalay Kanyakumari District (IN); Karthik Swaminathan, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/487,837

(22) Filed: Jun. 19, 2009

Related U.S. Application Data
(60) Provisional application No. 61/093,763, filed on Sep. 3, 2008.

(51) Int. Cl. G06K 9/40; G06K 9/36; G06K 9/00

(52) U.S. Cl. 382/107; 382/274; 382/232; 382/168

(57) ABSTRACT

A sequence of image frames are processed to determine if a pair of image frames in the sequence contain a same content, but have different global luminances. If the global luminances are different despite the content being the same, the global luminance of one of the image frames in the pair is adjusted to reduce the difference in the global luminances. The global luminance-adjusted image frames may be provided for further processing operations such as compression and global image stabilization. Reducing the global luminance difference may provide benefits such as improvements to compression and global image stabilization.

### RELATED APPLICATION(S)

The present application claims the benefit of co-pending U.S. provisional application Ser. No. 61/093,763, entitled: “Method and Apparatus for Pattern Matching with Linear Temporal Luminance Variation”, filed on Sep. 3, 2008, naming the same inventors as in the subject application, and is incorporated in its entirety herewith.

### BACKGROUND OF THE INVENTION

1. Technical Field

Embodiments of the present disclosure relate generally to image processing, and more specifically to processing video frames with the same content but with luminance variation across frames.

2. Related Art

Images of a scene may be captured, for example using video cameras, in the form of a corresponding sequence of video frames (image frames), with each video frame containing multiple pixels having corresponding pixel values. The content of a video frame refers to the specific details of the scene captured, such as shapes, boundaries, location, etc., of objects in the scene. An example of generation of successive frames having substantially the same content is when such successive frames are captured of a scene that have objects remaining in the same state/position unchanged while capturing the frames. Thus, the location, shapes, etc., of objects in each of such frames would also be substantially the same.

However, video frames with the same content may still exhibit substantial variations in the global (overall, i.e., considered over the entirety of the frames) luminance or brightness. Luminance variation between two video frames with the same content, thus, refers to differences between the values of the luminance (or brightness) component of pixels in identical locations in each of the two frames. Such luminance variations, despite same content, may be caused, for example, due to factors such as changes in the lighting conditions (e.g., light flicker) between time intervals or instance at which the frames are captured, drawbacks in auto-exposure techniques used in the video camera, lens aperture variations with respect to time, etc.

In general, it is desirable that any corrective action, as suited for the corresponding environment, be taken depending on the requirements of the environment.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

According to an aspect of the present invention, a sequence of image frames are processed to determine if a pair of image frames in the sequence contain a same content, but have different global luminances. If the global luminances are different despite the content being the same, the global luminance of one of the image frames in the pair is adjusted to reduce the difference in the global luminances.

In an embodiment, the global luminance-adjusted image frames are provided for further processing operations such as compression and global image stabilization. Reducing the global luminance difference may provide benefits such as improvements to compression and global image stabilization.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### BRIEF DESCRIPTION OF THE VIEWS OF DRAWINGS

Example embodiments of the present invention will be described with reference to the accompanying drawings briefly described below.

FIG. 1 is a block diagram of an example environment in which several aspects of the present invention can be implemented.

FIGS. 2A and 2B show two image frames with the same content, but with different global luminance levels.

FIG. 3A is a diagram showing the variations in projection vector values of a pair of frames having a same content but with different global luminances.

FIG. 3B is a curve illustrating the variations in the values of the sum of absolute differences (SAD) obtained from a pattern matching (correlation) operation.

FIG. 3C is a curve illustrating the variations in the values of the mean absolute difference (MAD) obtained from a pattern matching operation.

FIG. 3D is a curve illustrating the variations in the values of the sum of squared errors (SSE) obtained from a pattern matching operation.

FIG. 4 is a flowchart illustrating the manner in which video frames with luminance variation, but with the same content, are processed, in an embodiment.

FIG. 5 is a block diagram illustrating the internal details of a processing unit in an embodiment.

FIG. 6 is a diagram illustrating the projection vectors of blocks of a frame in an embodiment.

FIG. 7 is a flowchart illustrating the manner in which difference in global luminance is determined in an embodiment.

FIGS. 8A and 8B are histogram plots of luminance signal components in respective image frames.

FIG. 9 is a diagram showing a best-fit straight line obtained from peak positions in histograms of a pair of frames.

FIG. 10A is a diagram showing the variations in projection vector values of a pair of frames having a same content after adjustment of global luminance levels according to an aspect of the present invention.

FIG. 10B is a curve illustrating the variations in the values of the sum of absolute differences (SAD) obtained from a pattern matching (correlation) operation after adjustment of global luminance levels according to an aspect of the present invention.

FIG. 10C is a curve illustrating the variations in the values of the mean absolute difference (MAD) obtained from a pattern matching operation after adjustment of global luminance levels according to an aspect of the present invention.

FIG. 10D is a curve illustrating the variations in the values of the sum of squared errors (SSE) obtained from a pattern matching operation after adjustment of global luminance levels according to an aspect of the present invention.

FIGS. 11A and 11B are diagrams illustrating computation of projection vector sums of corresponding blocks of respective ones of a pair of frames.

The drawing in which an element first appears is indicated by the leftmost digit(s) in the corresponding reference number.

### DETAILED DESCRIPTION

Various embodiments are described below with several examples for illustration.

1. Example Environment

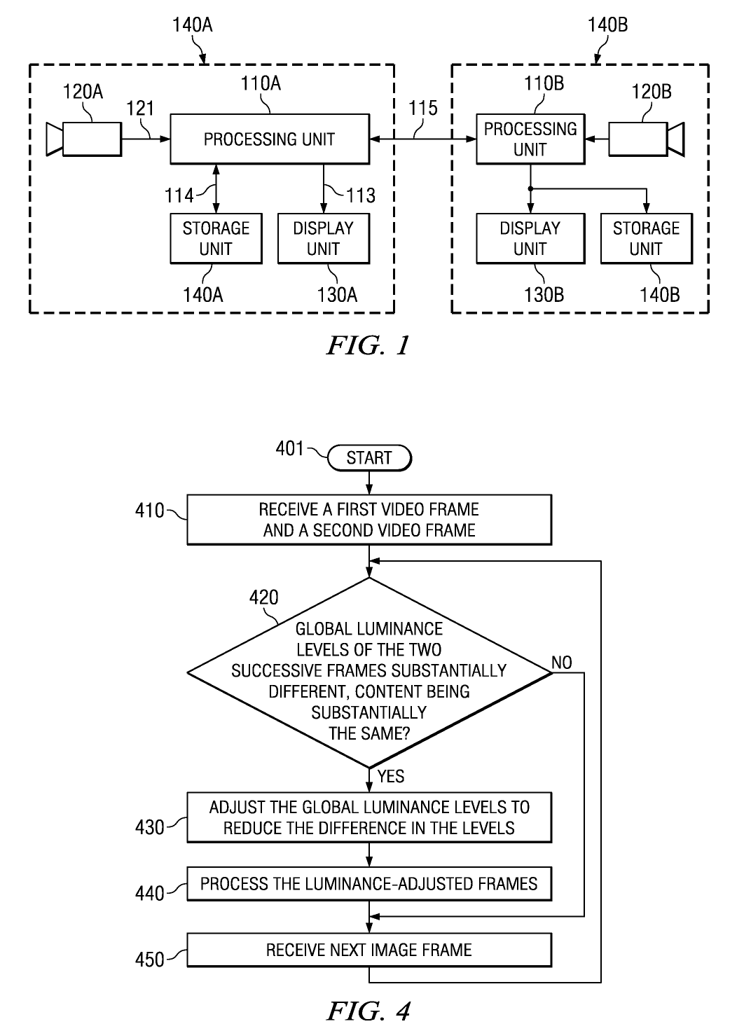

FIG. 1 is a block diagram illustrating an example environment in which several features of the present invention may be implemented. The example environment is shown containing only representative systems for illustration. However, real-world environments may contain many more systems/components as will be apparent to one skilled in the relevant arts. Implementations in such environments are also contemplated to be within the scope and spirit of various aspects of the present invention.

The diagram is shown containing end systems 140A and 140B designed/configured to communicate with each other in a video conferencing application. End system 140A is shown containing processing unit 110A, video camera 120A, display unit 130A and storage unit 140A. End system 140B is shown containing processing unit 110B, video camera 120B, display unit 130B and storage unit 140B. Processing unit 110B, video camera 120B, display unit 130B and storage unit 140B respectively operate similar to processing unit 110A, video camera 120A, display unit 130A and storage unit 140A of end system 140A, and their description is not separately provided.

Video camera 120A captures images of a scene, and forwards the captured image (in the form of corresponding video/image frames) to processing unit 110A on path 121. The images captured represent physical objects. Each image frame may be represented by a number of pixels, for example, each in RGB, YUV or any of several well-known formats.

Processing unit 140B may receive compressed and encoded image frames on path 115, and process the frames further, for example, to decode, decompress and display the frames. End system 140A may similarly receive image frames (e.g., in compressed and encoded format) from end system 140B, and the pair of end systems may operate to provide various video conferencing features.

Processing unit 110A may perform one or more processing operations on the image frames received from video camera 120A. The processing operations include storage of the image/video frames, via path 114, in storage unit 140A (which may be a non-volatile storage component), display of the image frames on display unit 130A (via path 113), image stabilization and image compression and encoding. Processing unit 110A may transmit encoded image frames on path 115.

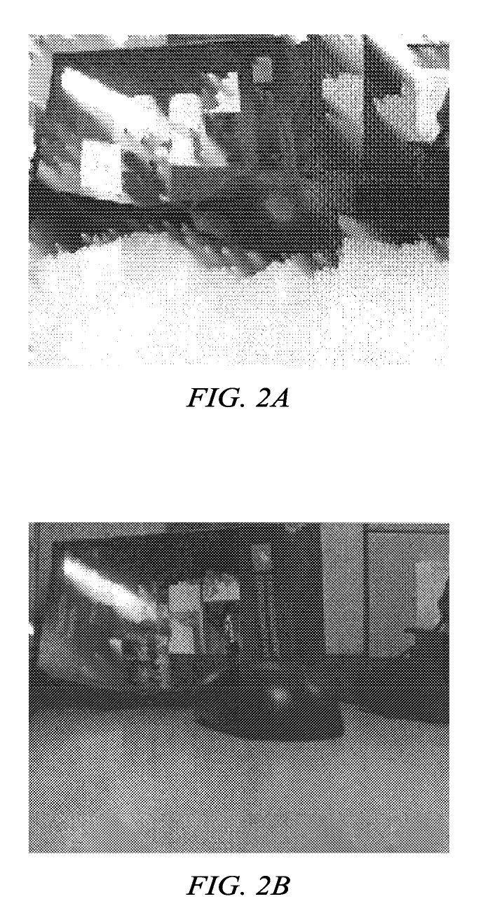

The video frames received from video camera 120A (on path 121) may have substantially the same content, but with luminance variations across frames. An example is illustrated with respect to FIGS. 2A and 2B, which show two image frames with the same content, but with different global luminances, as may also be noted visually. The image frames of FIGS. 2A and 2B may represent scenes captured in quick succession, and with the same camera position and viewing angle, and with the details of the scene not having changed for the duration of the two capture intervals. Therefore, the image frames are termed as having the same content. Thus, the location, size, orientation, etc., of objects in the scene represented by the two image frames are (substantially) identical.

It may be observed, however, that the global luminance of the image frame of FIG. 2A is greater than the global luminance of the image frame of FIG. 2B. The term global luminance refers to luminance (brightness) of the entire image frame as a whole, as against regional or block luminance which refers to luminance of regions or portions within the frame. The difference in global luminance between the image frames corresponds to differences between luminance components of pairs of pixels in the same location (co-ordinates) in the two image frames.

Thus, for example, assuming the pixels of the frames are represented in YUV (or YCbCr) color-space format, the Y (luminance) component of a pixel ‘A’ in the image frame of FIG. 2A may be greater than the Y-component of a pixel ‘B’ in the same location (as pixel ‘A’) in the image frame of FIG. 2B. Further, it may be appreciated that the same relationship (difference) may exist (for the luminance component) between each of the pairs of pixels in the same location in the corresponding frames (ignoring the effects of noise). When pixel values are represented in RGB color space, the luminance component may be distributed among the R, G and B values, as is well-known in the relevant arts.

Depending on the particular cause of luminance variation, the difference may be represented by a scale/gain factor, or by a more complex mathematical relationship. The relationship may be expressible for example, as a linear, quadratic, or in general a polynomial relationship. However, the luminance variation may be represented by other types of relationships.

Several drawbacks may be associated with such global luminance variations between a pair of frames. Some of the drawbacks are briefly noted next.

2. Pattern Matching

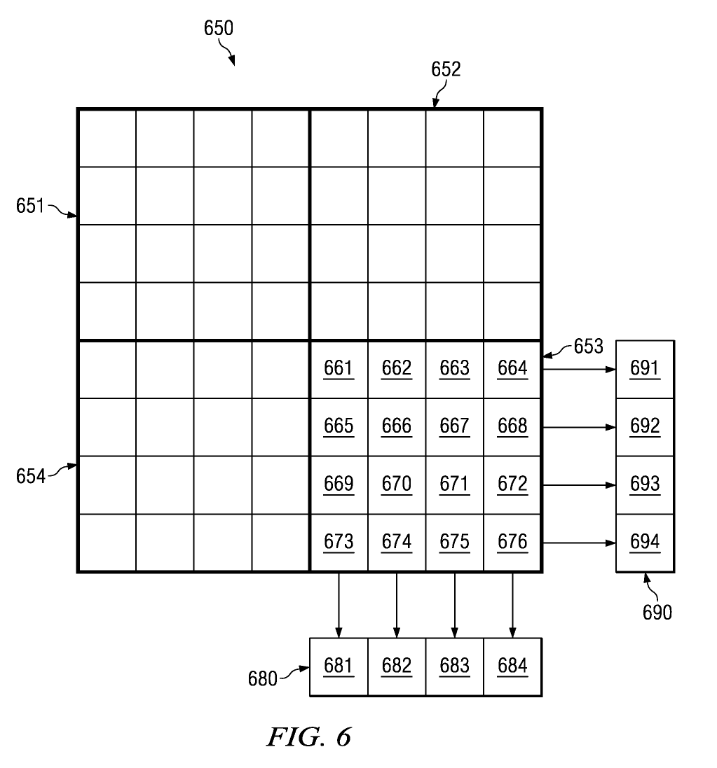

Several processing operations on image frames, including image compression and image stabilization, may involve pattern matching. Pattern matching with respect to image frames refers to determining the extent of similarity between two or more frames (e.g., how close the pixel values of corresponding locations in the image frames are), and may be performed using any of several well-known techniques. One technique of pattern matching entails the correlation of projection vectors of the corresponding frames. Projection vectors of a frame are illustrated with respect to an example image frame 650 of FIG. 6.

Image frame 650 of FIG. 6 is shown containing four equal-sized blocks (portions) 651, 652, 653 and 654. Each block is shown for simplicity as containing sixteen pixels, with the pixels of block 653 labeled 661 through 676. Denoting each component of a pixel (e.g., R, G or B; Y, U, or V, etc.) as a ‘signal component’ of a pixel, the set of sums of signal component values of columns forms a horizontal projection vector. The set of sums of signal component values of columns forms a vertical projection vector. Thus, horizontal projection vector 680 of block 653 is shown containing sums 681, 682, 683 and 684 of signal component values of columns in the block. Vertical projection vector 690 of block 653 is shown containing sums 691, 692, 693 and 694 of signal component values of rows in the block.

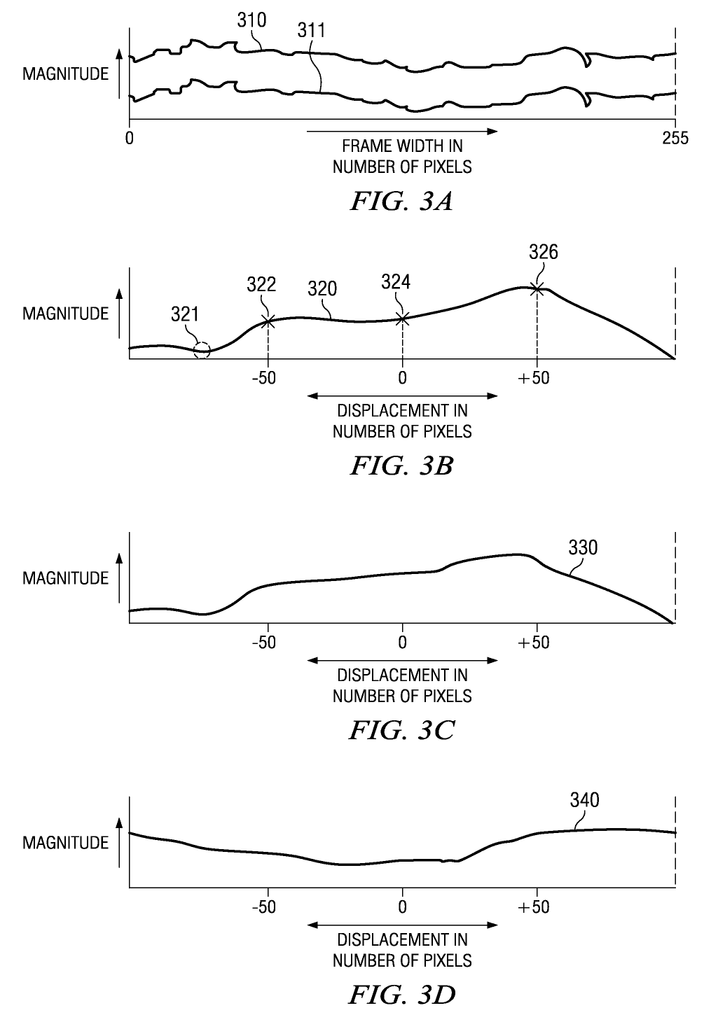

During pattern matching operations, correlation operations may be performed between projection vectors (horizontal or vertical) of correspondingly located blocks (blocks in the same location) in a pair of frames for which pattern matching is desired. Alternatively such matching may be performed using projection vectors computed for the whole frame rather than for blocks of the frames. Curve 310 of FIG. 3A represents the variations (as a function of frame width) in the values of horizontal projection vectors of the image frame of FIG. 2A, while curve 311 represents the variations in the values of horizontal projection vectors of the image frame of FIG. 2B.

In particular, the X-axis there contains as many points as the number of pixels in the width direction and the Y-axis represents the column sum of the projection vector for that pixel location. Thus, for the eight pixels along width direction shown in FIG. 6, there would be corresponding eight points on the X-axis of FIG. 3A. Four of these points would have the computed magnitudes corresponding to label 681-684.

Curves 320, 330 and 340 of respective FIGS. 3B, 3C and 3D, respectively represent the correlation values (as a function of displacement) generated according to (cost functions represented by) the sum-of-absolute difference (SAD), mean absolute difference (MAD), and sum of squared errors (SSE). With respect to curve 320, point 324 represents the sum of the differences on a point by point basis of curves 310 and 311 (for a displacement of 0 pixels). Point 322 on the other hand represents the sum of differences on a point-by-point basis after curve 311 is moved to the left by 50 pixel positions. Point 326 corresponds to similar number when curve 311 is moved to the right by 50 pixel positions.

As is well-known, a minimum value in the cost function curves indicates the location at which the corresponding frames/blocks of the frames are deemed to match.

It may be observed from the three curves 320, 330 and 340 that it may be difficult to determine a ‘true minimum’ value. Hence, it may be appreciated that luminance variations in general render pattern matching difficult. In general, when global luminance differences are present between two image frames, pattern matching is rendered difficult or may lead to erroneous conclusion about the similarity between the two frames. For example, a false minimum represented by point 321 may lead to the erroneous conclusion that a maximum similarity between the two frames occurs when one frame is displaced by an amount (with respect to zero) represented by point 321 (approximately 65 pixels to the left in the illustrative example there).

The manner, in which such drawbacks may be detected and processed, is described below with various examples.

3. Processing Luminance Variation

FIG. 4 is a flowchart illustrating the manner in which video frames with luminance variation, but with the same content, are processed, in an embodiment. The flowchart is described with respect to the device and components of FIG. 1, and in relation to processing unit 110A merely for illustration. However, various features described herein can be implemented in other environments and using other components, as will be apparent to one skilled in the relevant arts by reading the disclosure provided herein.

Furthermore, the steps in the flowchart are described in a specific sequence merely for illustration. Alternative embodiments using a different sequence of steps can also be implemented without departing from the scope and spirit of several aspects of the present invention, as will be apparent to one skilled in the relevant arts by reading the disclosure provided herein. The flowchart starts in step 401, in which control passes immediately to step 410.

In step 410, processing unit 110A receives a pair of video frames. The video frames may be generated at different time instances, and may, for example be successive frames in a set of frames. Control then passes to step 420.

In step 420, processing unit 110A determines if the global luminance levels of the two frames in the pair are different, but the content represented by the frames is the same. While the embodiments described below determine the difference of global luminance levels, it should be appreciated that alternative embodiments can determine the difference of global luminance levels on a smaller set of pixels, for example, to reduce computational complexity. In general, the computed difference needs to represent the difference of global luminance levels with a desired balance of accuracy and computational complexity. If the global luminance levels are different, with the contents being the same, control passes to step 430, otherwise control passes to step 450.

In step 430, processing unit 110A adjusts the global luminance levels of the frames to reduce the difference in the levels. In an embodiment, processing unit 110A makes the global luminance levels equal by changing the luminance level of only one of the two frames. Control then passes to step 440.

In step 440, processing unit 110A processes the luminance-adjusted frames. The processing may include pattern matching, compression, motion vector estimation, image stabilization, etc. Control then passes to step 450.

In step 450, processing unit 110A receives a next image frame. Processing unit 110A sets the later-generated (and subsequently adjusted in step 430) frame in the pair received in step 410, and the next image frame as a ‘next’ pair of frames. Control then passes to step 420, and the corresponding steps may be executed repeatedly.

Thus, an aspect of the present invention reduces the luminance variation between frames which otherwise have a same content, and forwards the luminance-adjusted frames for further processing. When performing compression subsequently, the luminance-adjusted frames are used, rather than the ‘original’ frames (i.e., frames prior to the operations of the flowchart described above). In particular, by using the luminance adjusted frames, motion estimation may be performed accurately and easily. In an alternative embodiment, the luminance adjusted image frames may be used for motion estimation, while the pre-corrected frames are used thereafter in forming the compressed data.

It may be appreciated that the global luminance levels of each of the frames may be adjusted so that the levels become equal (or difference in levels is reduced). Alternatively, the global luminance level of only frame may be adjusted to equal that of the other frame. Luminance variations, thus compensated, may enable better compression of the frames (achieve a higher compression ratio).

Other benefits include reduced image jitter when performing image stabilization, and easier and more accurate pattern matching in general. When performing global image stabilization subsequently, the luminance-adjusted frames are used, rather than the ‘original’ frames (i.e., frames prior to the operations of the flowchart described above).

It should be appreciated that the features of the flowchart described above can be implemented in various environments. However, the implementation is illustrated with respect to an example embodiment of processing unit 110A described next.

4. Processing Unit

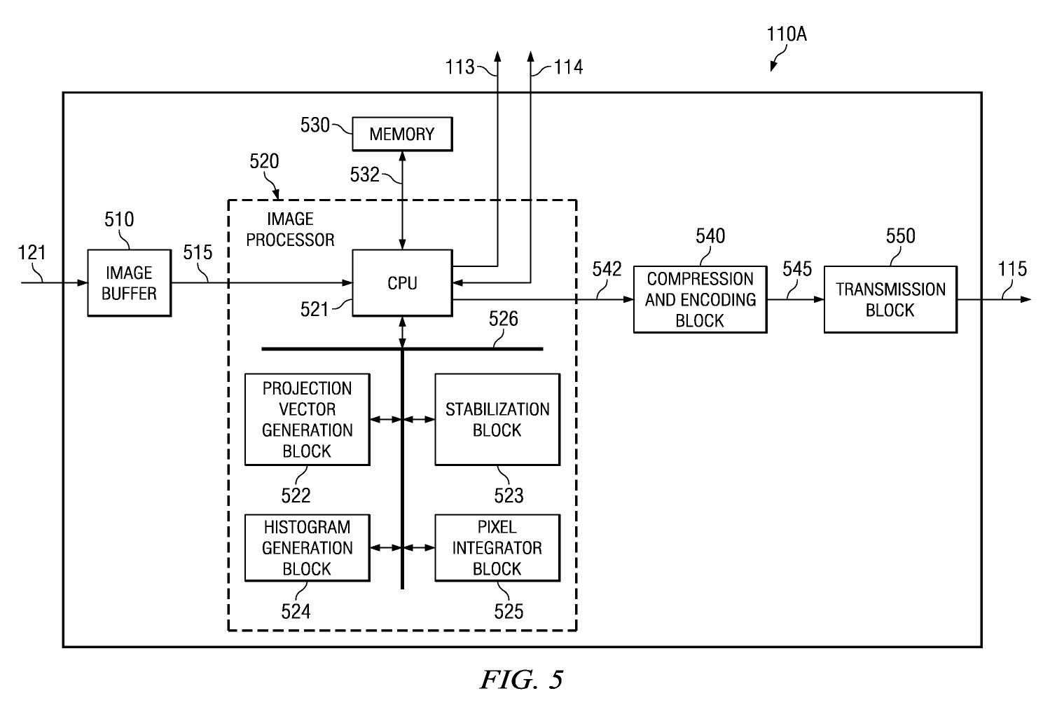

FIG. 5 is a block diagram illustrating the internal details of a processing unit in an embodiment. Processing unit 110A of FIG. 1 is shown in FIG. 5 as containing image buffer 510, image processor 520, memory 530, compression and encoding block 540, and transmission block 550. Again, the blocks and components shown in FIG. 5 are merely representative, and more or fewer blocks, as well as combinations of blocks, may be used in other embodiments. In an embodiment, some or all of the operations of image processor 520 are performed by a Texas Instruments TMS320DM355 Digital Media System-on-Chip (DMSoC).

Image buffer 510 stores image frames received on path 121 (in the form of corresponding pixels values), and provides the stored frames on path 515. It should be appreciated that some of the image frames thus received and stored may have the same content, but different luminance levels.

Memory 530 stores program (instructions) and/or data (provided via path 532) for use by image processor 520, and may be implemented as RAM, ROM, flash, etc, and thus may contain volatile in addition to non-volatile storage elements. Thus, memory 530 includes a computer readable (storage) medium having stored therein instructions and/or data. However, the computer (or machine, in general) readable storage medium can be in other forms (e.g., non-removable, or removable, etc.). Thus computer readable storage medium refers to any medium on which instructions can be stored and then retrieved for execution by one or more processors. The instructions thus executed provide several features of the flow chart of FIG. 4 described above.

Image processor 520 processes image frames (stored in image buffer 510) and is shown containing CPU 521, projection vector generation block 522, stabilization block 523, histogram generation block 524 and pixel integrator block 525. Various other blocks may, in addition, be contained in image processor 520, but are not shown as not being relevant to the description herein. In particular, image processor processes video frames having the same content, but with luminance variations across frames, to provide several features of the present invention, as described in detail below.

CPU 521 executes instructions stored in memory 530 to provide the image processing features noted above with respect to image processor 520. The features/operations may include color-space conversion and auto-white balance (AWB) prior to the adjustments in accordance with the features described with respect to FIG. 4, and image resizing/scaling and smoothing, brightness and contrast adjustments, etc., after the features of FIG. 4. CPU 521 may communicate via bus 526 with projection vector generation block 522, stabilization block 523, histogram generation block 524 and pixel integrator block 525.

Projection vector block 522 generates horizontal and/or vertical projection vectors of blocks (portion within a frame) in a frame or an entire frame. The block sizes and numbers may be programmable via corresponding instructions executed by CPU 521. Projection vectors are described with respect to FIG. 6 above.

Stabilization block 523 operates to correct global displacements/shifts in one frame with respect to another (earlier or reference frame) due to unintended camera shake, referred to as global image stabilization. Global image stabilization is designed to correct for shifts in the entire region of a frame (with respect to another frame), and is not designed to correct for changes/shifts only in a region or portion of a frame.

Histogram block 524 generates histograms (frequency distribution patterns) of pixel values of a frame or blocks of a frame. Pixel integrator block 525 provides a sum of brightness as well as color component values of selected pixel groups (e.g., within a block or the entire frame). In an embodiment, CPU 521, projection vector generation block 522, histogram generation block 524 and pixel integrator block 525 correspond respectively to ‘ARM926EJ-S core’, ‘histogram module’, ‘H3A module’, and ‘boundary signal calculator (BSC) module’ contained in TMS320DM355 (DMSoC) noted above.

CPU 521 forwards processed and/or unprocessed image frames on path 542. CPU 521 may forward processed and/or unprocessed image frames on paths 113 and 114 respectively for display and storage (recording).

Compression and encoding block 540 compresses and encodes image frames received on path 542. In an embodiment, compression and encoding are performed consistent with the MPEG4 standard. Compression and encoding block 540 provides compressed and encoded frames to transmission block 550 via path 545.

Transmission block 550 modulates one or more carriers with the compressed and encoded data received, and transmits the modulated signal (which may be generated, for example, according to OFDM techniques) on path 115. It is noted that although path 115 is shown as a wired path in FIG. 1, in other embodiments/environments, the path may represent a wireless transmission medium. Compression and encoding block 540 and transmission block 550 may be implemented in a known way.

The manner in which image processor 520 estimates the amount by which the global luminance between a pair of frames, and corrects for such differences is described in detail next.

5. Detection of When Content is Substantially the Same

In general, content is said to be the same when the chroma/color (U-V of YUV and Cb-Cr of YCbCr space) components of two frames (on a pixel-by-pixel basis) are the same. Thus, in theory, the color component of each pixel may be compared on a pixel-by-basis to see the extent of match and then determine whether the two frames have the same content depending on a desired degree of match.

However, more computationally efficient approaches may be employed for a similar conclusion based on sub-set of such data or different representation of the same information. Examples of such approaches include using spectral analysis, pattern matching, using only one of the components (e.g., R component in RGB space, U component of YUV space, etc.).

It may be further appreciated that there are often components/modules to determine the content similarity (for various image processing operations), and the output/determination of such components/modules can be conveniently used to check whether the content is the same.

In an embodiment, each image frame is divided into multiple blocks (e.g., 3×3) and the pixel values of the blocks may be compared/examined statistically to determine whether the content is the same. Projection vectors (similar to FIG. 6) may be computed of a component data (e.g., color G or U component), and spectral analysis may be performed to extract the spectral components of the projection vectors for each frame. The spectral components are then compared to determine whether the contents are same or not.

When G component is used, it may be appreciated that the pixel values would contain partly color and partly luminance information. Accordingly, the same data can be used for detecting content similarity and extent of difference of luminance (as being acceptable within a desired degree of error), as described with examples below.

6. Detection and Estimation of Luminance Difference Using Histograms

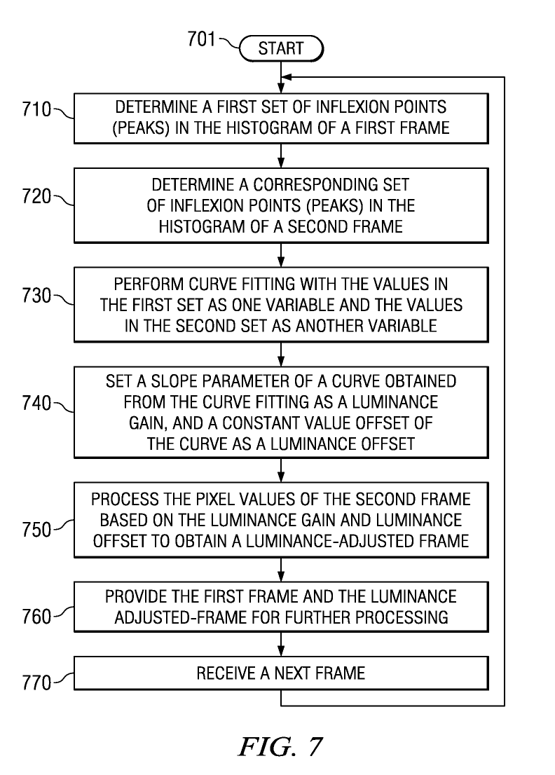

FIG. 7 is a flowchart illustrating the manner in which difference in global luminance is determined in an embodiment. Again, the flowchart is described with respect to the device and components of FIGS. 1 and 2, and in relation to image processor 520, merely for illustration. However, various features described herein can be implemented in other environments and using other components, as will be apparent to one skilled in the relevant arts by reading the disclosure provided herein. The steps in the flowchart are described in a specific sequence merely for illustration.

Further, while the operations of the flowchart of FIG. 7 are described as being performed based on information generated using histograms, in general the operations may be may be extended without substantial differences to techniques which are based on finding a relationship by which the global luminances of a pair of frames are related, as is further elaborated below with example. The flowchart starts in step 701, in which control passes immediately to step 710.

In step 710, image processor 520 determines a first set of inflexion points in the histogram of a first frame. The histogram maps a frequency of occurrence of each of possible luminance level of the pixels of the first frame. An inflexion point generally shows a clear change of direction/slope of the histogram plot (from up to down or vice versa), and thus can be a peak or trough. Control then passes to step 720.

In step 720, image processor 520 determines a corresponding set of inflexion points (peaks) in the histogram of a second frame. The second frame may be generated at a later time instance than the first frame. Control then passes to step 730.

In step 730, image processor 520 performs curve fitting with the values in the first set as one variable and the values in the second set as another variable. Control then passes to 740.

In step 740, image processor 520 sets a slope parameter of a curve obtained from the curve fitting as a luminance gain, and a constant value offset of the curve as a luminance offset. Control then passes to step 750.

In step 750, image processor 520 processes the pixel values of the second frame based on the luminance gain and luminance offset to obtain a luminance-adjusted frame. In an embodiment, image processor 520 multiplies the luminance component of each pixel of the second frame by the luminance gain and adds the luminance offset to each product. Control then passes to step 760.

In step 760, image processor 520 provides the first frame and the luminance adjusted-frame for further processing. Control then passes to step 770, in which image processor 520 receives a next frame. Image processor 520 sets the luminance-adjusted frame and the next frame as the ‘next set’ of first frame and second frame respectively. Control then passes to step 710, and the corresponding operations may be repeated. The operations of the flowchart described above are illustrated next with respect to example diagrams.

7. Histograms

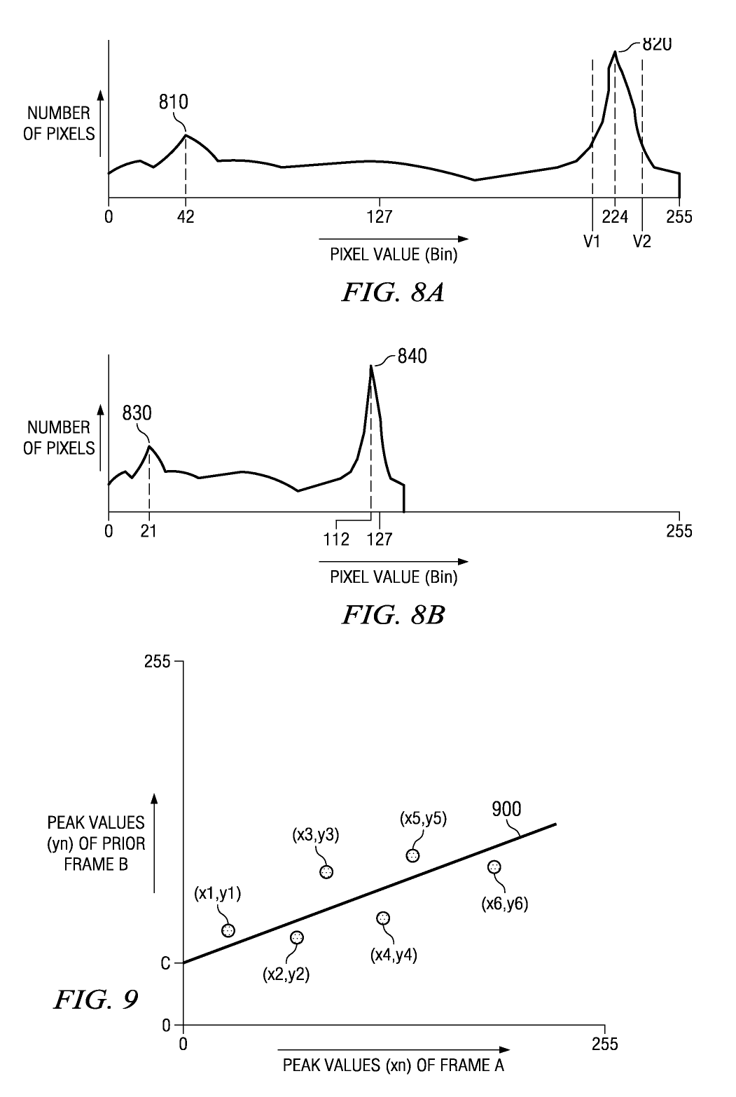

FIG. 8A is a histogram plot of the values of a signal component representing luminance of pixels of an image frame (referred to for convenience as frame A), in an embodiment. The signal components representing luminance may be Y values (from YUV/YCbCr representation) or any one of R, G and B values (preferably G, since G may have a better correlation with luminance) from an RGB representation. The values (e.g., 0 through 255) of the luminance signal component are shown plotted along on the X-axis (marked in the Figure as pixel values), and the corresponding number of values for each Y-axis value are shown plotted along the X-axis. Although, the plot of FIG. 8A shows a frequency distribution (histogram) for each possible value of the luminance signal component, histograms plots for groups of values (bins) of the luminance signal component, and the corresponding number of occurrences of luminance signal components in each bin may also be used instead.

FIG. 8B is a histogram plot of the values of a luminance signal component of pixels of another image frame (frame B), which contains the same content as frame A, but has a global luminance that is lesser than that of frame A. It may be observed that while the overall shape/appearance of the two plots is similar (since content is the same), the histogram of FIG. 8B spans fewer luminance signal component values. It may be appreciated that such a ‘compaction’ of the histogram (with respect to that of FIG. 8A) occurs due to the lesser global luminance of frame B compared to the global luminance of frame A.

In an embodiment, frame B represents a frame captured at a time instance earlier than frame A. Frame A and frame B may thus also be viewed as a current frame and a previous frame respectively. Each of the histograms may be generated by an independent hardware unit such as histogram block 524 (FIG. 5), or may by execution of instructions by CPU 521, in a known way.

Image processor 520 determines in the plot of frame A, inflexion points (e.g., peaks such as 810 and 820, or in general points in the histogram plot where the slope of the distribution changes by more than a predetermined threshold, which in turn can be computed dynamically). Corresponding to each peak, image processor 520 then creates a window of values with the peak as centre. An example window of values ranging from V1 to V2 id shown in FIG. 8A, with peak 820 as the centre position of the window.

Image processor 520 then matches the shape of the curve/plot in the windows with the histogram plot of frame B, to determine corresponding peak values. Thus, image processor 520 may determine that peaks 840 and 830 of FIG. 8B correspond respectively to peaks 820 and 810 of FIG. 8A. The matching technique noted above may be performed in a known way.

Image processor 520 stores the luminance signal component values (or frequency bin numbers of bins are used instead) of the peaks. Thus, in the example above, image processor 520 stores the values 224 and 112 (corresponding respectively to peaks 820 and 840), as well as values 42 and 21 (corresponding respectively to peaks 810 and 830). Image processor 520 than determines the relationship between the peaks of frame A and frame B.

Although only two peaks are shown in each of FIGS. 8A and 8B, image processor 520 may determine more numbers of corresponding peaks in each of the histogram plots of FIGS. 8A and 8B. Image processor 520 may then determine the relation between the values in the two sets of sets of peaks using well-known techniques.

In an embodiment, image processor 520 divides a luminance signal component value corresponding to a peak (referred to as a peak position for convenience) in frame A by the peak position of the corresponding (matched) peak in frame B. Thus, for example, image processor 520 may divide the value 224 (of peak 820) by the value 112 (of peak 840), to obtain a gain factor of 2. It is noted that in the example the ratio of value 42 of peak 810 to the value 21 of peak 830 is also 2.

Image processor 520 may thus determine that the global luminance of frame A has a gain factor of 2 with respect to the global luminance of frame B. Image processor 520 multiplies luminance signal component value representing luminance of each pixel in frame B by the gain factor of 2, such that the global luminances become equal. Alternatively, image processor 520 may divide the luminance signal component values representing luminance of each pixel in frame A by the gain factor of 2.

Typically, however, the ratios of all corresponding peak position pairs across the two frames may not evaluate to the same number. Therefore, image processor 520 uses statistical techniques such as curve fitting (well-known in the relevant arts) to determine a final luminance gain.

In some scenarios, in addition to a luminance gain (which may also be viewed as the luminance difference noted above), a constant luminance offset may also be present between the global luminances of frames A and B. Such a constant luminance offset may result, for example, due to execution of various image processing techniques in the frames, such as auto-white balance (AWB), also well-known in the relevant arts.

In an embodiment, when a luminance offset is present in addition to a luminance gain, image processor 520 operates to determine both the unknown parameters (luminance gain and luminance offset) by plotting the peak positions of one frame on one axis, and the peak positions of the other frame on another axis, as shown in FIG. 9.

In FIG. 9, x1 through x6 (xn in general) represent six peak positions in one frame, while y1 through y6 (yn in general) represent six peak positions in the other frame. The simultaneous equations to be solved for the two unknowns (luminance gain ‘m’ and luminance offset ‘c’) define a straight line, and expressed by the set of equations below:

yn=m(xn)+c Equation 1

wherein, n is an index having values from 1 through as many number of peak positions as are considered for solving the above set of equations,

‘m’ is the luminance gain sought to be determined, and

‘c’ is the luminance offset sought to be determined.

Image processor 520 then determines a best-fit straight line (900 in FIG. 9) for the set of peak points (xn, yn). The slope of the line 900 equals ‘m’, and the y-axis intercept of line 900 equals ‘c’. Image processor 520 multiplies the luminance signal components of each pixel of frame B by luminance gain ‘m’, and adds the luminance offset ‘c’ to the product, to cause the global luminance of frame B to equal that of frame A, or at least to reduce the difference in their global luminance.

In an alternative embodiment, image processor 520 may determine the ‘m’ and ‘c’ based on multiple signal components (e.g., R, G and B) to improve the estimate of ‘m’ and ‘c’. In such a scenario, three corresponding values may be determined for each of m and c, and statistical approaches (e.g., mean, median) can be used to select a respective final value for m and c.

While image processor 520 is described as using statistical techniques such as curve fitting (linear regression) to determine ‘m’ and ‘c’, other well known techniques may also be used, as would be apparent to one skilled in the relevant arts on reading the disclosure herein.

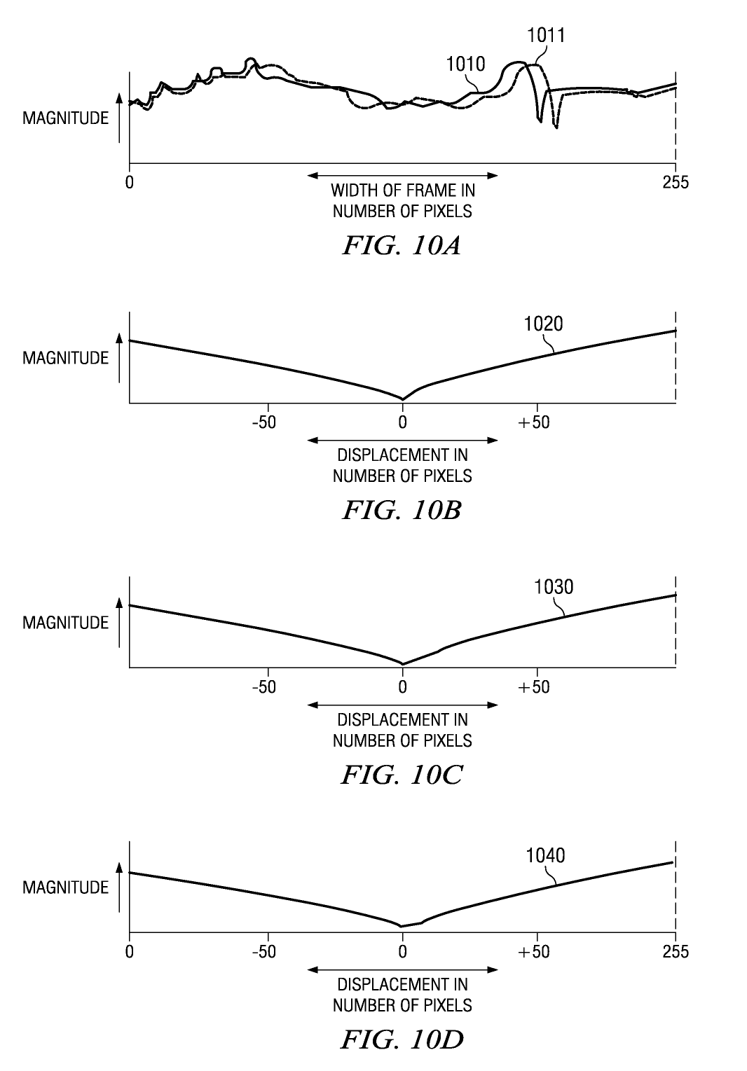

Curves 1010 and 1011 of FIG. 10A represent the variations in the values of horizontal projection vectors of a pair of image frames after global luminance adjustment performed in a manner described above. The pre-luminance-adjusted frame (i.e., original frames) are similar to the image frames of FIGS. 2A and 2B, in that the ‘original’ frames contain the same content but differ in their global luminances. It may be observed that after processing of the frames (e.g., multiplication of the luminance components of each pixel of the frame with the lower global luminance by the computed luminance gain followed by addition by the luminance offset) to reduce global luminance difference, cost functions SAD (curve 1020 of FIG. 10B), MAD (curve 1030 of FIG. 10C), and SSE (curve 1040 of FIG. 10D) show a clear minimum at zero displacement.

It is noted that image processor 520 may additionally base a final determination of the luminance gain and luminance offset on past history of frames (previous frames) as well, such as when content is determined to be the same across a large number of frames. Image processor 520 may compare luminance gain and offset values computed for past frames with those computed for a current pair of frames. If there is substantial difference between the computed gain and offsets, image processor 520 may examine the peak positions across the past frames. A peak position, for which a luminance gain is substantially different across the past frame, may be eliminated from being considered in the computations for a ‘current’ pair of frames. Several other reliability indicators may also be checked by image processor 520.

It is noted with respect to the description above that, in the event corresponding peak positions in the frames are equal (or nearly equal), image processor 520 may conclude that there is no luminance variation between the frames. On the other hand, if image processor 520 does not find corresponding peaks in the frames, image processor 520 may conclude that a global luminance difference alone is not present, and that the frames potentially do not contain the same content. Alternatively, the technique may be applied block-wise and if threshold number of corresponding blocks (of the respective frame) have matching peaks, image processor 520 may still conclude that there is no luminance variation between the frames (though there could be motion within other not-compared blocks).

The techniques of Flowchart of FIG. 7, illustrated above with respect to histograms may be used based on other relationships (i.e., other than histograms/frequency distributions) between the global luminances of two frames. In an embodiment, luminance gain and luminance offset are estimated based on projection vectors of blocks (or the entire frames) of a pair of frames, as described next with respect to FIGS. 10A and 10B.

8. Detection and Estimation of Luminance Gain Using Projection Vectors

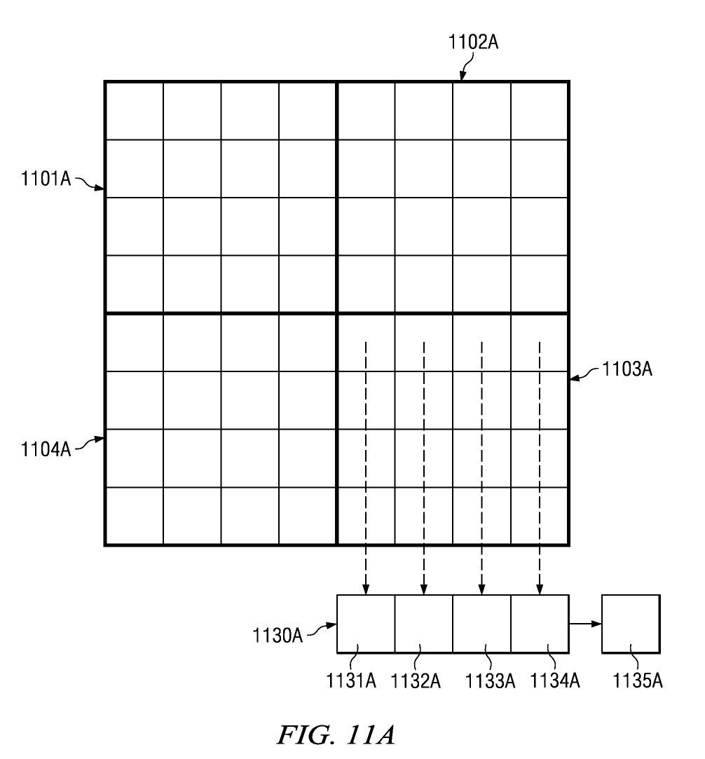

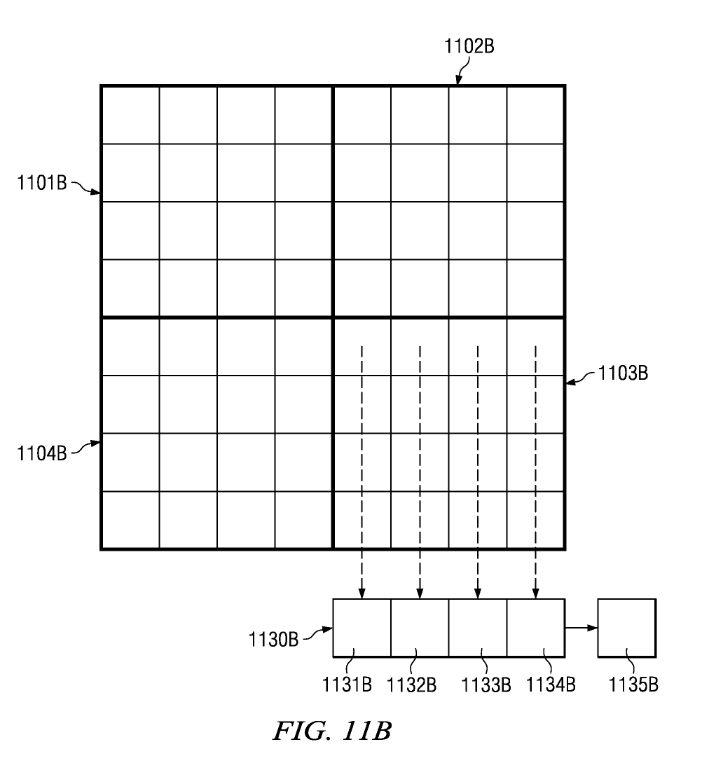

In an alternative embodiment, image processor 520 computes projection vectors for one or more blocks of each of a pair of frames, again referred to conveniently as frame A and frame B, and shown respectively in FIGS. 11A and 11B. Image processor 520 divides each of the frames into multiple blocks. For illustration, frames A and B are shown divided into four blocks each.

Image processor 520 obtains projection vectors for each of the blocks. The projection vectors may be provided by a hardware block such as projection vector block 522 (FIG. 5) or may be obtained by the execution of instructions by CPU 521. Horizontal projection vectors 1130A and 1130B for a pair of corresponding blocks (same relative location in each of the frames) are shown in FIGS. 11A and 11B respectively. Image processor 520 adds the values in a projection vector to obtain a single number. Thus, the sum of columns of block 1103A (FIG. 11A) are shown labeled as 1131A, 1132A, 1133A and 1134A in the horizontal projection vector 1130A. The sum of columns of block 1103B (FIG. 11B) are shown labeled as 1131B, 1132B, 1133B and 1134B in the horizontal projection vector 1130B.

Image processor 520 adds the values in a projection vector to obtain a corresponding ‘projection vector sum’. Projection vector sums 1135A and 1135B of respective values of horizontal projection vectors 1130A and 1130B are also shown in respective FIGS. 11A and 11B. Image processor 520 computes projection vector sums for the other corresponding block pairs (1101A/1101B, 1102A/1102B and 1104A/1104B) in the frames.

The relationship between corresponding projection vector sum is denoted as in equation 1 above. Thus, for example, image processor 520 may set the projection vector sums of frame A as yn, and projection vector sums of frame B as xn. Image processor 520 solves the set of equations [yn=m(xn)+c] for multiple values of n (equal to the number of blocks in a frame) in a manner similar to that described above, to obtain luminance gain ‘m’, and luminance offset ‘c’. Although the description above is provided with respect to horizontal projection vectors, it may be appreciated that vertical projection vectors can also be used instead.

In another embodiment, the projection vector sums of blocks may be provided directly by pixel integrator block 525, and operations similar to those described above may be performed obtain the luminance gain and luminance offset values.

In yet another embodiment, image processor 520 may use a combination of two or more of the techniques described above to obtain the luminance gain and luminance offset values. In such an approach, image processor 520 may compare the values obtained for the luminance gain and luminance offset by the different techniques, for greater reliability.

Frames, thus compensated for luminance variations, improve subsequent processing operations such as compression, image stabilization, and pattern matching in general.

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of processing a set of image frames, said method comprising:
checking whether a pair of image frames have a same content, but different global luminance; and
adjusting the luminance of one of said pair of image frames such that a difference of the global luminance of the pair of frames is reduced.

2. The method of claim 1, wherein said pair of image frames are successive image frames of a same scene captured by a video camera, said same scene containing a plurality of physical objects.

3. The method of claim 2, further comprising:
compressing data representing said set of image frames, wherein the image frame with the adjusted luminance is used instead of the corresponding image frame of the set of image frames in said compressing.

4. The method of claim 3, wherein said compressing comprises:
performing motion estimation of a portion in one of said pair of frames with respect to the other one of said pair of frames,
wherein said motion estimation is performed after said adjusting and based on the image frame with the adjusted luminance instead of the corresponding image frame of the set of image frames.

5. The method of claim 2, further comprising:
performing global image stabilization in said set of image frames,
wherein said global image stabilization is performed after said adjusting and based on the image frame with the adjusted luminance instead of the corresponding image frame of the set of image frames.

6. The method of claim 2, further comprising finding a relationship by which the global luminance of said first frame is related to the global luminance of said second frame,
wherein said adjusting modifies a value of each pixel in one of said first frame and said second frame according to said relationship to reduce said difference.

7. The method of claim 6, wherein said finding comprises:
forming a first histogram and a second histogram related respectively to said first frame and said second frame, wherein each histogram indicates a corresponding number of pixels in the related frame having the corresponding luminance level; and
processing said first histogram and said second histogram to determine said relationship.

8. The method of claim 6, wherein said finding comprises:
forming a first set of projection vector and a second set of projection vectors related respectively to said first frame and said second frame; and
processing said first set of projection vectors and said second set of projection vectors to determine said relationship.

9. The method of claim 6, wherein said finding comprises:
forming a first sum and a second sum related respectively to said first frame and said second frame, wherein each sum is obtained by adding pixel values in the same coordinates of a block of pixels in the corresponding frame; and
processing said first sum and said second sum to determine said relationship.

10. The method of claim 6, wherein said relationship comprises a polynomial, wherein said finding comprises ascertaining the coefficients of said polynomial by examining said first frame and said second frame.

11. A machine readable medium storing one or more sequences of instructions for enabling a system to process image frames, wherein execution of said one or more sequences of instructions by one or more processors contained in said system causes said system to perform the actions of:
checking whether a pair of image frames have a same content, but different global luminance; and
adjusting the luminance of one of said pair of image frames such that a difference of the global luminance of the pair of frames is reduced.

12. The machine readable medium of claim 11, wherein said pair of image frames are successive image frames of a same scene captured by a video camera, said same scene containing a plurality of physical objects.

13. The machine readable medium of claim 12, further comprising:
compressing data representing said set of image frames, wherein the image frame with the adjusted luminance is used instead of the corresponding image frame of the set of image frames in said compressing.

14. The machine readable medium of claim 13, wherein said compressing comprises:
performing motion estimation of a portion in one of said pair of frames with respect to the other one of said pair of frames,
wherein said motion estimation is performed after said adjusting and based on the image frame with the adjusted luminance instead of the corresponding image frame of the set of image frames.

15. The machine readable medium of claim 12, further comprising:
performing global image stabilization in said set of image frames,
wherein said global image stabilization is performed after said adjusting and based on the image frame with the adjusted luminance instead of the corresponding image frame of the set of image frames.

16. The machine readable medium of claim 12, further comprising finding a relationship by which the global luminance of said first frame is related to the global luminance of said second frame,
wherein said adjusting modifies a value of each pixel in one of said first frame and said second frame according to said relationship to reduce said difference.

17. The machine readable medium of claim 16, wherein said finding comprises:
forming a first histogram and a second histogram related respectively to said first frame and said second frame, wherein each histogram indicates a corresponding number of pixels in the related frame having the corresponding luminance level; and
processing said first histogram and said second histogram to determine said relationship.

18. The machine readable medium of claim 16, wherein said finding comprises:
forming a first set of projection vector and a second set of projection vectors related respectively to said first frame and said second frame; and
processing said first set of projection vectors and said second set of projection vectors to determine said relationship.

19. A digital processing system comprising:
a random access memory (RAM);
a processor; and
a machine readable medium to provide a set of instructions which are retrieved into said RAM and executed by said processor, wherein execution of said set of instructions causes said digital processing system to perform the actions of:
checking whether a pair of image frames have a same content, but different global luminance; and
adjusting the luminance of one of said pair of image frames such that a difference of the global luminance of the pair of frames is reduced.

20. The digital processing system of claim 19, wherein said pair of image frames are successive image frames of a same scene captured by a video camera, said same scene containing a plurality of physical objects.
